(19) United States
(12) Patent Application Publication
(10) Pub. No.: US 2012/0318535 A1
(43) Pub. Date: Dec. 20, 2012

(54) PANEL TYPE EXTINGUISHER VESSEL

(75) Inventors: Dong Seob Park, Incheon (KR); Chang Ki Park, Incheon (KR)

(73) Assignee: FPG KOREA CO., LTD., Incheon (KR)

(21) Appl. No.: 13/515,496

(22) PCT Filed: Nov. 29, 2010
(86) PCT No.: PCT/KR2010/008495

§ 371 Date: Jun. 12, 2012

(30) Foreign Application Priority Data
Dec. 9, 2009 (KR) 10-2009-0121955

(51) Int. Cl. A62C 35/02

(52) U.S. Cl. 169/26

(57) ABSTRACT

The invention is about a panel type extinguisher vessel which is safe and secure and it is prevented from expanding deformation due to the pressurized extinguishing agent. The extinguisher vessel of the invention is in the shape of panel having a front plate and a rear plate with the inner space between them, and the vessel further includes a connecting member extending through the inner space to connect the front plate and the rear plate, and at least one of the reinforcing grooves are formed on the front plate and the rear plate.

### TECHNICAL FIELD

The invention relates to a panel type extinguisher vessel, and more particularly to a panel type extinguisher vessel which is safe and secure and it is prevented from expanding deformation due to the pressurized extinguishing agent.

### BACKGROUND INVENTION

Usually, an extinguisher is furnished in the building to extinguish the fire or delay the fire spreading until the fire engines arrives. The conventional extinguishers are in the shape of cylinder, and by removing the safety pin, the inflator is actuated and the extinguishing agent may be ejected. But these cylindrical extinguishers occupy considerable space in the room of the building, so it may hinder the traffic of passerby or it may not be in harmony with the surrounding interior design.

Recently, a panel-shaped extinguisher is introduced which can be embedded in the wall, ceilings or door and eject the extinguishing agent automatically when the fire breaks out. But the flat vessel of this panel type extinguisher is relatively weak in strength than that of the cylindrical extinguisher and it may be deformed or inflated by the pressurized extinguishing agent. Therefore, the panel type extinguisher is not yet regarded as safe or acceptable in respect of breakability and possible explosion.

### DISCLOSURE

### Technical Problem

The invention is suggested to solve the above problems and the object of the invention is to provide a safe and rigid panel type extinguisher vessel which has no concern of inflating deformation or explosion, it can be easily installed in the door or wall and be moved if necessary.

### Technical Solution

According to the invention, there is provided a panel type extinguisher vessel; which contains an extinguishing agent and on which an ejecting means is attached, wherein the vessel is in the shape of panel having a front plate and a rear plate with the inner space between them, and the vessel further includes a connecting member extending through the inner space to connect the front plate and the rear plate, and at least one of the reinforcing grooves are formed on the front plate and the rear plate.

### Advantageous Effects

According to the invention, as the vessel is formed as panel shape and the front plate and the rear plate are structurally connected by the connecting member, the panel type vessel of the invention can be prevented from inflating of the front panel and the rear panel by the pressurized extinguishing agent and explosion due to the damage or deformation of the vessel. And the reinforcing grooves formed on the front plate and the rear plate also increase the rigidity of the vessel to achieve a more safe and secure extinguisher.

### DESCRIPTION OF DRAWINGS

The above and other objects and advantages of the invention will become more apparent by describing the preferred embodiments with reference to the accompanying drawings in which:

FIG. 1 is a perspective view of the embodiment of the invention.

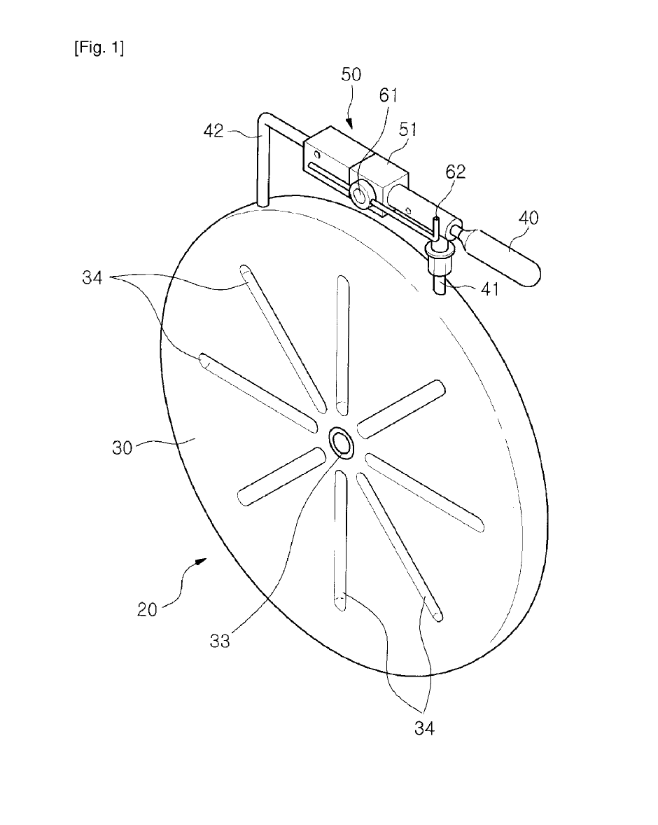

FIG. 2 is a sectional view of the embodiment of the invention.

FIG. 3 is a sectional view of one portion of the embodiment of the invention.

FIG. 4 is a front view of another embodiment of the invention.

### BEST MODE

Hereinbelow, the extinguisher according to preferred embodiments of the invention will be described with reference to the accompanying drawings. As shown in the drawings, the extinguisher vessel of the preferred embodiment comprises a rounded panel shaped vessel 20 with the front panel 30 and the rear panel 31 and in which an extinguishing agent is charged. An ejecting means 50 is attached on the outer part of the vessel 20. A connecting member 33 is provided at the center of the vessel 20 and connects the front plate 30 and the rear plate 31. A Plurality of reinforcing grooves 34 are formed on the surface of the front plate 30 and the rear plate 31 and extend from the connecting member 33 radially.

The ejecting means 50 comprises an inflator 40 and an ejecting module 51. The inflator 40 is an airtight vessel charged with the pressurized gas to eject the extinguishing agent. The ejecting module 51 is connected to vessel 20 through an inflow line 41 and outflow line 42. The inflow line 41 is formed at one end of the ejecting module 51 adjacent to the inflator 40 and it induces the high pressure gas from the inflator 40 to the vessel 20. The outflow line 42 is formed at the other end of the ejecting module 51 and it induces the pressurized extinguishing agent from the vessel 20 to the ejecting module 51 and eventually to the outside of the extinguisher via nozzles 66. The ejecting means 50 can be changed with various forms and it may be embedded inside the vessel 20.

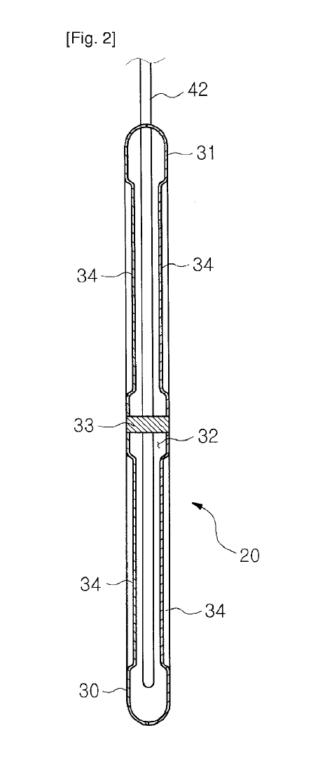

The detailed structure of the vessel 20 will be described with reference to FIG. 2. The front plate 30 and the rear plate 31 are in a disc shape and form an inner space between them with predetermined width. The shape of the front plate 30 and the rear plate 31 may be rectangle, triangle or other proper shapes. The front plate 30 and the rear plate 31 can be bent along the periphery of the plates or it can be attached by another strip member and welded with each other to form an airtight vessel. Or it may be formed as an integral body. The width of it is preferably determined to be embedded in the door panel or it may be an ordinary picture frame width such as 3 to 5 cm. The material of the vessel 20 is preferably metal but other materials can be used.

A connecting member 33 is provided in the vessel 20 to connect the front plate 30 and the rear plate 31 through the inner space of the vessel 20. The connecting member 33 penetrates the center of the front plate 30 and the rear plate 31 and welded with them in an airtight manner. The connecting member 33 may be a hollow short pipe, a sold rod or other proper one. The number and the position of the connecting member 33 can be properly determined according to the size of the plates 30, 31. The connecting member 33 increases the structural rigidity against the possible inflating deformation of the vessel 20.

A plurality of reinforcing grooves 34 are formed on the surface of the plate 30, 31 and extend from the connecting member 34 in radial direction. The reinforcing grooves 34 also increase the rigidity of the vessel 30 so it can prevent the possible inflating deformation of the vessel.

The extinguisher according to the invention can be embedded inside the door panel and automatically eject the extinguishing agent when the fire is sensed, or it may be hung on the wall and covered by the picture frame or other proper decorations and, in case of fire, the user can take it to the fire site and actuate it manually to eject the extinguishing agent.

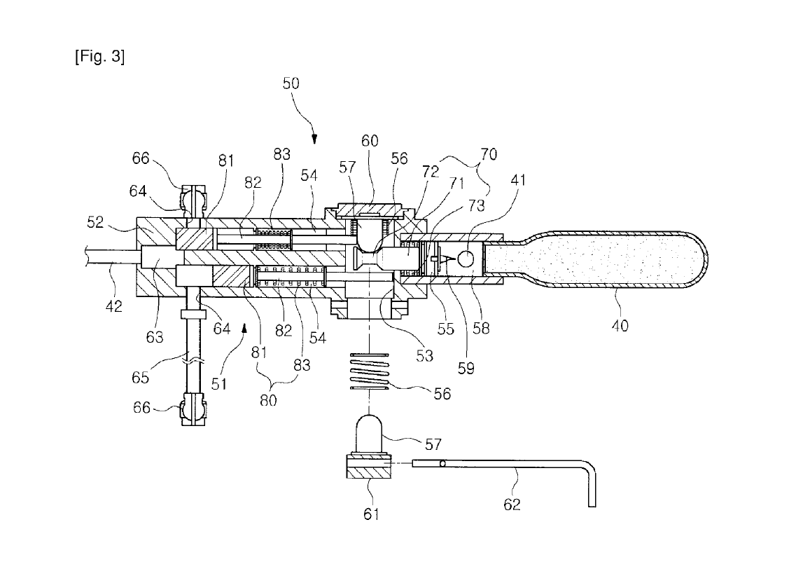

The ejecting means 50 of the preferred embodiment of the invention is described with reference to FIG. 3. The ejecting means 50 includes an ejecting module 51 which may be automatically or manually operated to actuate the inflator 40. The ejecting module 51 includes a striking assembly 70 supported by the thermally fusible plug 60 and the plug 61 removable by the safety pin 62 and a valve 80 supported by the striking assembly 70. The ejecting module 51 includes module body 52 engaged with the inflator 40 and connected to the vessel 20 through the inflow line 41 and the outflow line 42. The module body 52 also includes a stopper hole 53, valve holes 54 and an axial hole 55 which are interconnected with each other. The stopper hole 53 extends the module body 52 transversely, and a pair of stoppers 57 supported by the spring 56 is inserted in the stopper holes 53.

On one side of the stopper hole 53 is inserted a plug 61 which is attached on one stopper 57, the plug 61 being engaged with the module body 52 by the removable safety pin 62. On the other side of the stopper hole 53 is inserted the thermally fusible plug 60 which is attached on the other stopper 57. The thermally fusible plug 60 melts down when the fire breaks out. The axial hole 53 is formed on the central part of the stopper hole 53 toward the inflator 40. The striking assembly 70 is inserted in the axial hole 53. The striking assembly 70 is supported by the stoppers 57 and when the stoppers 57 are released, the striking assembly 70 will strike and actuate the inflator 40. The striking assembly 70 includes a movable rod 71 which is supported by the stoppers 57 at the neck 72 and is elastically pressed by the spring 73 toward the inflator 40. At the front end of the striking assembly 70 is provided a striking pin 59 which can be hit by the movable rod 71 and then actuate the inflator 40.

The module body 52 includes a pair of parallel valve holes 54 on the opposite side of the axial holes 55. The valve holes 55 connect to the outflow line 42 through a hole 63. Another hole 64 is formed on one side of the valve hole 54, and a pipe 65 is connected to this hole 64. Nozzle 66 is engaged with the end of the pipe 65, through which the extinguishing agent will be ejected. The inflow line 41, the valve hole 54, the holes 63, 64 and pipe 65 are all interconnected and constitute the outflow passage of the extinguishing agent. To close and open the outflow passage, a valve 80 is provided in the valve hole 54. The valve 80 includes a valve body 81 to block the outflow passage, a valve stopper 82 extending from the valve body 81 and supported on the stopper 57, and a spring 83 which elastically supports the valve stopper 82. If the stopper 57 is retreated by melting down of the thermally fusible 60 or manually removing of the safety pin 62, then the valve stopper 82 will be moved by force of the spring 83 and the valve body 81 will open the outflow passage.

According to the above mentioned structure, if the plug 61 or the thermally fusible plug 60 is removed manually or automatically by heat sensing, the mechanically combined operation of the striking assembly 70 and operation of valve assembly may incur ejecting of the extinguishing agent through the nozzle 66. If the safety pin 52 is manually removed, the extinguishing agent will eject through the pipe 65 and the fire hose (not shown). If the thermally fusible plug 60 is automatically removed by heat sensing, the extinguishing agent will eject through the other nozzle 66.

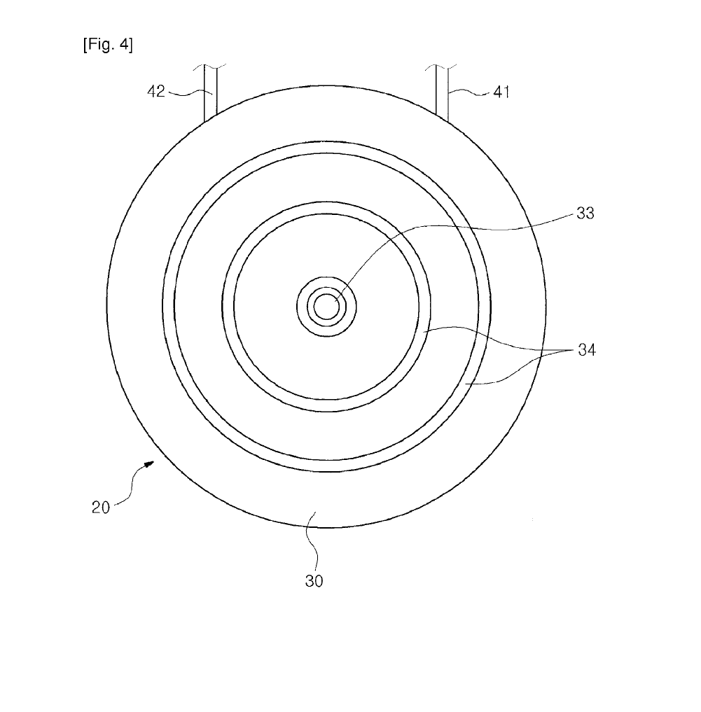

FIG. 4 shows another embodiment of the invention, in which concentric reinforcing grooves 34 are formed on the front plate 30 and rear plate 31. The reinforcing grooves 34 may be in the wave pattern or other proper patterns. The inflator 40 may be actuated by chemical reactions, or by pressurized gas, liquefied gas or other proper methods. A band or strip may be further attached to the vessel 20 to easily move the extinguisher.

1. A panel type extinguisher vessel which contains an extinguishing agent and on which an ejecting means is attached, wherein the vessel is in the shape of panel having a front plate and a rear plate with the inner space between them, and the vessel further includes a connecting member extending through the inner space to connect the front plate and the rear plate, and at least one of the reinforcing grooves are formed on the front plate and the rear plate.
